(19) United States
(12) Patent Application Publication
(10) Pub. No.: US 2018/0201055 A1
(43) Pub. Date: Jul. 19, 2018

(54) Spray Paint Cap Wristband

(71) Applicant: Jonathan Wakuda Fischer, Seattle, WA (US)

(72) Inventor: Jonathan Wakuda Fischer, Seattle, WA (US)

(21) Appl. No.: 15/406,741

(22) Filed: Jan. 15, 2017

(51) Int. Cl. B44D 3/00; A44C 5/00

(52) U.S. Cl. CPC B44D 3/00; A44C 5/0007

(57) ABSTRACT

The present invention comprises a spray paint cap wristband consisting of an adjustable, flexible band sized in length and a fastener for securing the invention around a worker's arm. Several holding receivers, with the same dimensions as the cap stems, are positioned along the exterior length of the band for easy storage and access of the spray paint caps.

### CROSS-REFERENCES TO PREVIOUS APPLICATIONS BY SAME INVENTOR

This is a continuation application of Provisional patent application: “Spray Paint Cap Wristband” Application No. 62/279,356 filed Jan. 15, 2016

### CROSS-REFERENCES TO RELATED APPLICATIONS

U.S. Pat. No. 4,923,105A *1988-08-081990-05-08 Snyder James MUtility belt
U.S. Pat. No. 5,593,073A *1995-04-111997-01-14 Finnegan; Danny Workman's wrist band

### BACKGROUND OF THE INVENTION

Regarding nomenclature: the plastic nozzles or tips attached to aerosol paint cans for spraying will henceforth be referred to as ‘caps.’ Artists who use aerosol paint utilize a variety of spray paint caps for their different pressure/coverage qualities. These caps often look identical except for minute differences. All standard spraypaint caps have a universal stem system (male or female) which attaches to the can during use.

Artists often work on ladders or around dangerous work areas, where hands free use and storage of tools is a vital issue. A spray painter must often switch between caps, so quick identification/manipulation is very important. This simple task can be difficult and time consuming if the caps are stored together (i.e. storage container). Using several different containers can solve this problem but access can be unsafe in these environments.

### BRIEF SUMMARY OF THE INVENTION

This wearable spray paint cap holder with a plurality of holding receivers to securely display spray paint caps. This invention can be made out of any material that can both hold the spray cap securely on the wristband, and allow manipulation (addition/removal) for easy access. With this system the painter can designate different areas of the band to different types, for both new and used caps. Instant visual identification means workplace speed and safety are both greatly increased.

Certain embodiments of the present invention include, but are not limited to, a rubber composite that allows stretching/flex of the wristband ‘base’ but still securely holds caps with a more densely constructed holding receiver. Other embodiments could include different receiver designs for female caps, or metal holders integrated into other materials, such as fabric, leather, etc.

### BRIEF DESCRIPTION OF DRAWINGS

FIG. 1A is a black and white photograph, which is necessary to share the exact proof-of-concept: The tops of spray paint cans are cut off and affixed to a wristband, allowing spray paint caps to be held securely but also removed and manipulated with one hand.

FIG. 1B illustrates a three dimensional view of the bracelet/base on the wrist with holding receivers (with the same sized aperture as the spraycan top) to securely hold, display, and re-arrange spray paint caps.

FIG. 2A shows a top down view of the wristband/bracelet with a plurality of holding receivers.

FIG. 2B depicts the side view of the invention and a cutaway view of the apertures of the holding receivers.

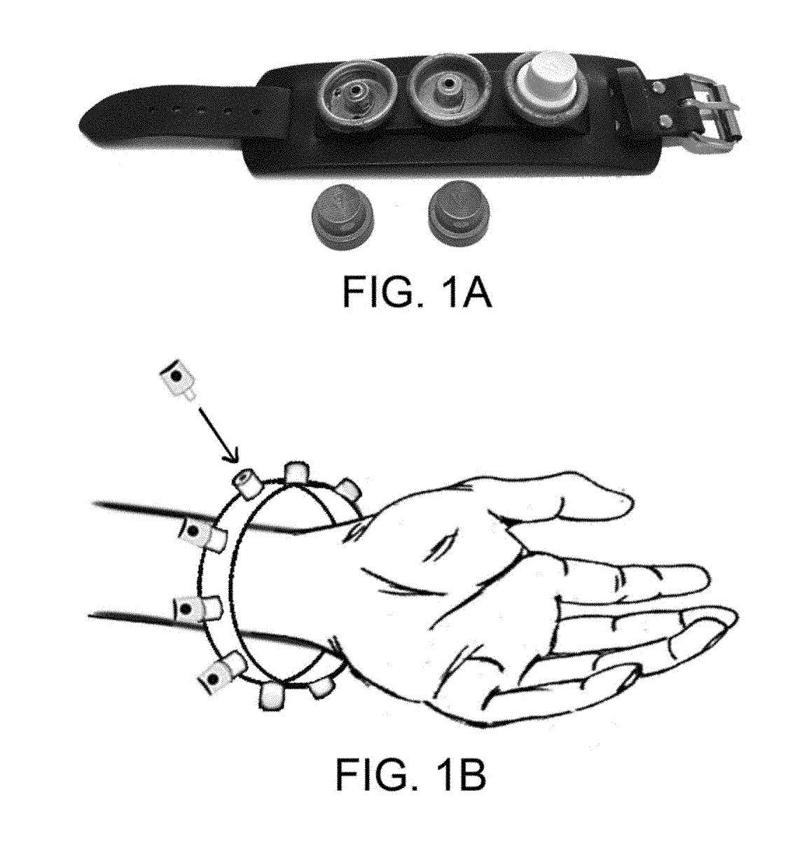

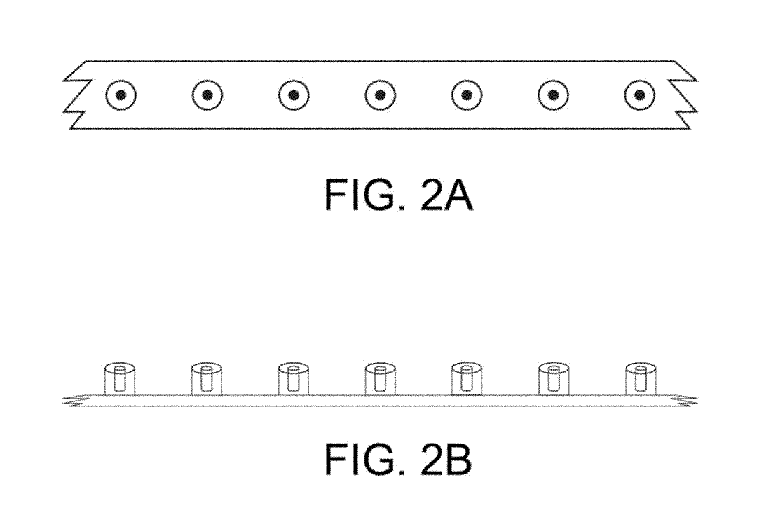

### DETAILED DESCRIPTION OF THE INVENTION

The present invention provides a wearable solution for storing a plurality of spray paint caps for storage and easy access. An embodiment of the invention employs the holder comprising a support having a ring formed from a flexible elongated band designed to pass over a hand and onto the wrist. The support may be made from an elastic material, such as silicone rubber, and is designed to stretch over the hand and recoil around the wrist to secure the holder in position thereon. Other embodiments of this support may be adjustable using a buckle system, hook and loop or other configurations.

The invention further comprises a plurality of holding receivers, which have the same size aperture of the spray paint cap stems. Other referenced patents use a wristband with pouches/magnets/velcro/etc to store tools, but these receivers must be specific dimensions to both store and allow easy access to the caps. The receiver may be made from an elastic material, such as silicone rubber, and is designed to stretch around the cap stem by increasing the diameter of the apertures receiving the caps.

The illustrations depict an invention to be worn on the painter's wrist, with one row of holding receivers. However, other embodiments could include multiple rows of receivers, with a thicker width of wearable band. The ability to securely display spray paint caps so the painter can easily identify and manipulate these tools will add to increased speed and safety in any situation.

I claim:

1. A spray paint cap holding wristband comprising: a flexible band sized in length to wrap around the wrist of a worker, said band having interior and exterior portions, and a fastener for securing said band around said workers wrist;
A plurality of cap holding receivers, with the same dimensions as the spray paint cap stems, positioned on the exterior length of the band;
Whereby spray paint caps are inserted into said holding nipples for storage and convenient access.

2. The spray paint cap holding wristband of claim 1, wherein said fastener comprises a hook and loop fastener.

3. The spray paint cap holding wristband of claim 1, wherein said fastener comprises a belt and buckle.

4. The spray paint cap holding wristband of claim 1, wherein said fastener comprises laces.

5. The spray paint cap holding wristband of claim 1, wherein the holding receiver apertures are the same dimensions as male spray paint caps.

6. The spray paint cap holding wristband of claim 1, wherein the holding receiver apertures are the same dimensions as female spray paint caps.

7. The spray paint cap holding wristband of claim 1, wherein there is one row of holding receivers running the length of the invention.

8. The spray paint cap holding wristband of claim 1, wherein there are multiple rows of holding receivers running the length of the invention.
